(19) United States
(12) Patent Application Publication
(10) Pub. No.: US 2024/0427024 A1
(43) Pub. Date: Dec. 26, 2024

(54) CORRECTING LOCATION ERRORS USING GEOFENCES

(71) Applicant: Textron Innovations Inc., Providence, RI (US)

(72) Inventors: Ionut Gabriel Bungeanu, Arges (RO); Luiza Iuliana Stoica, Pitesti (RO); Radu Selea, Pitesti (RO)

(21) Appl. No.: 18/341,408

(22) Filed: Jun. 26, 2023

(51) Int. Cl. G01S 19/14; G01S 19/42; H04W 4/021

(52) U.S. Cl. CPC G01S 19/14; G01S 19/42; H04W 4/021

(57) ABSTRACT

A technique corrects errors in locations of a vehicle in response to current locations falling within one or more geofences that define regions where the vehicle is unlikely to be traveling. In response to a current location of the vehicle falling within the bounds of such a geofence, the technique adjusts the current location by a defined offset. The offset has the effect of modifying the current location toward a more likely, actual location of the vehicle.

### BACKGROUND

GPS (Global Positioning System) technology has found widespread use in a variety of applications. Chief among these have been mapping applications for vehicles. One particular application of GPS technology is tracking the locations of golf carts. Such tracking can provide many benefits both to operators of golf courses and to players. For example, precisely determining the location of a golf cart enables a software program to compare that location with those of golf greens and other areas not to be entered by golf carts and to alert players that they should back up or choose different routes. Also, knowing the precise location of a golf cart permits the software program to compute the distance to a golf pin, thereby helping players to select proper clubs and to judge how hard they should hit the ball.

Standard GPS has an accuracy of approximately 15 meters, and various solutions are available to improve this accuracy. For example, differential GPS (DGPS) uses arrays of fixed-position, ground-based stations, which provide reference signals that can be used by local GPS receivers to improve their native accuracy. Also, RTK (Real-Time Kinematic) positioning uses phase of a GPS signal's carrier wave and relies on a reference station or virtual station to provide real-time corrections. In addition, a software solution called “snap-to-road” works by aligning a GPS point to a nearest point on a road network.

### SUMMARY

The accuracy of standard GPS is often insufficient for golfing applications. For example, a 15-meter error in calculating distance to a pin can cause a golfer to select the wrong club. It can also represent a golf cart as being on a green (typically a violation of course rules) whereas the golf cart may be parked well off the green.

Unfortunately, existing solutions for improving GPS accuracy are often expensive or impractical. Differential GPS and RTK positioning normally require expensive hardware and may not be compatible with existing GPS infrastructures. Although snap-to-road is not expensive, it is generally too constraining for golf courses, where golf carts are normally allowed to drive on the grass or in other off-path locations. What is needed, therefore, is an inexpensive way of correcting GPS errors that is compatible with standard GPS technology and is effective regardless of whether drivers stay on designated roads or paths.

The above need is addressed at least in part by an improved technique that corrects errors in locations of a vehicle in response to current locations falling within one or more geofences that define regions where the vehicle is unlikely to be traveling. In response to a current location of the vehicle falling within the bounds of such a geofence, the technique adjusts the current location by a defined offset. The offset has the effect of modifying the current location toward a more likely, actual location of the vehicle. In some examples, the vehicle may encounter multiple such geofences, with each geofence contributing a correction offset in a respective direction and by a respective amount, enabling location measurements to be corrected in all relevant coordinate dimensions.

Certain embodiments are directed to a method of correcting location measurements. The method includes generating a current location of a vehicle based at least in part on GPS (Global Positioning System) signals received by a GPS receiver of the vehicle, identifying the current location on a virtual map, and adjusting the current location of the vehicle in response to detecting that the current location falls within a defined geofence on the map, said adjusting including applying a spatial offset to the current location.

In some examples, the spatial offset has a direction toward a vehicle path identified on the map.

In some examples, the spatial offset is defined by a set of parameters associated with the geofence, and adjusting the current location of the vehicle includes accessing the spatial offset from the set of parameters.

In some examples, the spatial offset has at least two orthogonal components that form a correction vector having a magnitude and a direction.

In some examples, the current location is one of multiple current locations generated based at least in part on GPS signals received by the vehicle over time, and the method further includes applying corrections repeatedly and cumulatively in response to current locations of the vehicle repeatedly falling within the geofence.

In some examples, the set of parameters that define the geofence further define a maximum cumulative correction that can be applied in response to current locations of the vehicle repeatedly falling within the geofence.

In some examples, the set of parameters associated with the geofence further defines a decay parameter, wherein the method further includes reducing a cumulative correction based on the decay parameter in response to current locations of the vehicle falling outside of the geofence.

In some examples, the geofence is a first geofence and the method further includes, in response to detecting that a second current location of the vehicle falls outside the first geofence and within a second geofence defined on the map, adjusting the second current location of the vehicle at least in part by applying a second spatial offset to the second current location, the second spatial offset being defined by a second set of parameters associated with the second geofence.

In some examples, the correction vector is a first correction vector, a second correction vector is formed by the second spatial offset, the second correction vector has a direction that differs from the direction of the first correction vector, and adjusting the second current location is based on both the first correction vector and the second correction vector.

In some examples, the first geofence encompasses an undrivable region that is impassible by the vehicle, and the second geofence encompasses a drivable region that is passable by the vehicle but does not include a defined path for the vehicle.

In some examples, a magnitude of the second offset is less than half the magnitude of the offset associated with the first geofence.

In some examples, the first geofence has a first offset-decay rate, the second geofence has a second offset-decay rate, and the first offset-decay rate is less than half the second offset-decay rate.

Other embodiments are directed to a method of correcting location measurements, which includes receiving, via a user interface, a definition of a geofence and storing a representation of the geofence at least in part using a set of parameters provided in one or more data structures. The set of parameters identifies a region to which the geofence is assigned on a virtual map and a spatial offset to be applied to location measurements falling within the geofence. The method further includes providing the set of parameters to a vehicle to enable the vehicle to correct its own measurements of location using the spatial offset.

In some examples, storing the representation of the geofence using the set of parameters further includes storing a maximum cumulative correction that can be applied to location measurements that repeatedly fall within the geofence.

In some examples, storing the representation of the geofence using the set of parameters further includes storing a decay parameter to be applied to cumulative corrections responsive to location measurements falling outside the geofence after having fallen within the geofence.

Still other embodiments are directed to a vehicle that includes a body, a computing device, and a GPS (Global Positioning System) receiver operatively coupled to the computing device. The computing device includes control circuitry constructed and arranged to generate a current location of the vehicle based at least in part on GPS signals received by the GPS receiver, identify the current location on a virtual map, and adjust the current location of the vehicle in response to detecting that the current location falls within a defined geofence on the map, the adjustment including applying a spatial offset to the current location.

In some examples, the spatial offset has a direction toward a vehicle path identified on the map.

In some examples, the current location is one of multiple current locations generated based at least in part on GPS signals received by the vehicle over time, and the control circuitry is further constructed and arranged to apply corrections repeatedly and cumulatively in response to current locations of the vehicle repeatedly falling within the geofence.

In some examples, the spatial offset is defined by a set of parameters associated with the geofence and the set of parameters further define a maximum cumulative correction that can be applied in response to current locations of the vehicle repeatedly falling within the geofence.

In some examples, the set of parameters associated with the geofence further define a decay parameter, and the control circuitry is further constructed and arranged to reduce a cumulative correction based on the decay parameter in response to current locations of the vehicle falling outside of the geofence after having fallen within the geofence.

Other embodiments are directed to a computerized apparatus constructed and arranged to perform any of the methods described above. Still other embodiments are directed to computer program products. Such computer program products store instructions which, when executed on control circuitry of a computerized apparatus, cause the computerized apparatus to perform any of the methods described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a diagram showing an example virtual map of a geographical area in which multiple geofences have been defined.

FIG. 3 is a diagram of an example data structure that stores parameters of a particular geofence.

FIG. 4 is a map view of a vehicle traveling adjacent to a geofence and showing corrections in current locations of the vehicle.

FIG. 5 is a diagram of an example arrangement for adjusting a location of a vehicle that has encountered multiple geofences, each contributing a respective correction.

FIG. 6 is a flowchart showing an example method of correcting locations.

FIG. 7 is a flowchart showing an example method of representing geofence parameters and providing them to a vehicle to enable the vehicle to adjust its own determined locations.

### DETAILED DESCRIPTION

Embodiments of the improved technique will now be described. One should appreciate that such embodiments are provided by way of example to illustrate certain features and principles but are not intended to be limiting.

An improved technique corrects errors in locations of a vehicle in response to current locations falling within one or more geofences that define regions where the vehicle is unlikely to be traveling. In response to a current location of the vehicle falling within the bounds of such a geofence, the technique adjusts the current location by a defined offset. The offset has the effect of modifying the current location toward a more likely, actual location of the vehicle.

Although it may not always be possible to know precisely where a vehicle is, we have recognized that it is often possible to know where a vehicle is not. A new type of geofence may be provided for this purpose, i.e., by defining a region where it is impossible or unlikely for a vehicle to be found, e.g., because the terrain is rocky, steep, densely vegetated, or has some other feature that makes it impassible or unlikely to be passed by the vehicle under normal circumstances. Upon detecting that the GPS location of a vehicle falls within such a geofence while still being within the error range of conventional GPS, it can be assumed with reasonable certainty that the location reading is erroneous. In many cases, the direction of the error can be inferred from the surrounding terrain. For example, if a path on a golf course passes between two steep, rocky cliffs and a GPS reading places a golf cart on top of one of the cliffs but still within the standard GPS error range, it can be inferred that the golf cart is actually on the path. An offset can then be applied to the GPS reading to move a representation of the golf cart in the direction of the path. As another example, the path may be nowhere nearby, but a GPS reading places the cart 10 meters into a body of water. As the GPS reading more likely reflects a location error than that the vehicle has driven into the water, an offset can be applied that adjusts the GPS reading toward the shore.

GPS errors tend to be stable over several minutes or even hours. Thus, an offset correction applied upon encountering a geofence may be sustained after the encounter and applied to subsequent GPS-determined locations. Also, encounters with multiple geofences may result in multiple offsets being asserted to adjust the vehicle's location, e.g., in different directions and by different amounts. In such cases, an overall correction may be calculated based on the individual offsets contributed by the respective geofences.

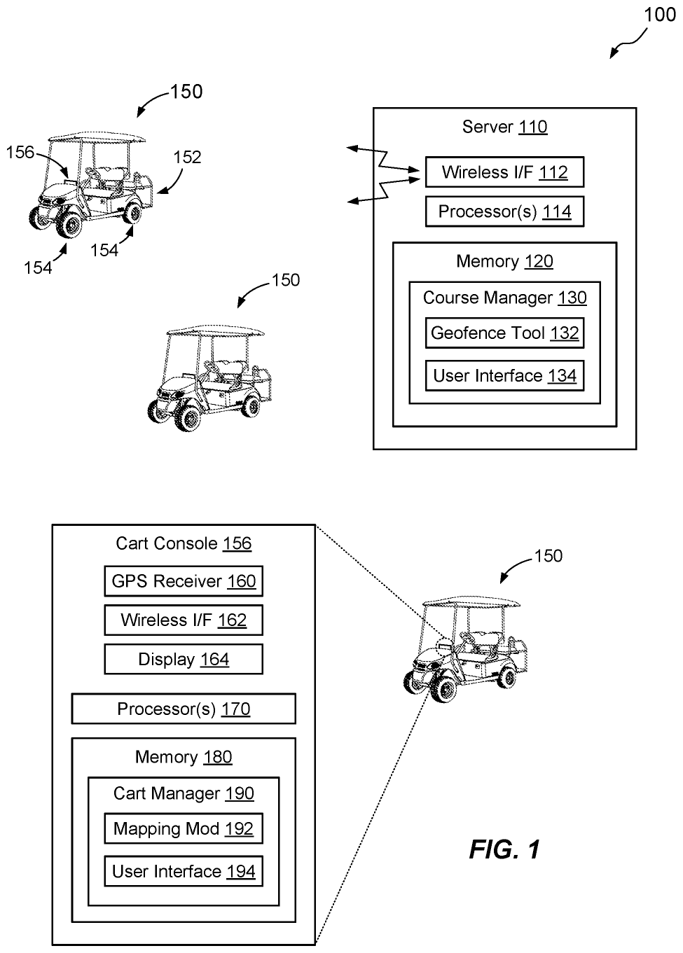

FIG. 1 shows an example environment 100 in which embodiments of the improved technique can be practiced. Here, a server 110 is provided in communication with multiple vehicles, such as golf carts 150. The server 110 may be disposed in a club house of a golf course or in some other location within wireless range of the golf carts 150. The server 110 may include, for example, a wireless interface 112, such as a Wi-Fi interface or cellular data interface, which is capable of wireless communication with the golf carts 150 as they travel around the course. Although not shown, an extended wireless infrastructure may be provided, which includes various boosters and/or repeaters, such that adequate signal coverage may be provided throughout the course.

The server 110 further includes one or more processors 114 and memory 120, which may include both volatile memory and non-volatile memory, such as one or more disk drives, solid state drives, and/or the like. The processor(s) 114 and the memory 120 together form control circuitry, which is constructed and arranged to carry out various methods and functions as described herein. Also, the memory 120 includes a variety of software constructs realized in the form of executable instructions. When the executable instructions are run by the processor(s) 114, the processor(s) 114 carry out the operations of the software constructs. Although certain software constructs are specifically shown and described, it is understood that the memory 120 typically includes many other software components, which are not shown, such as an operating system, various applications, processes, and daemons.

As further shown in FIG. 1, the memory 120 “includes,” i.e., realizes by execution of software instructions, a course manager 130, which may be provided as a software program configured to assist with managing certain aspects of the golf course. The course manager 130 includes or otherwise has access to a geofence tool 132 and a user interface 134. The geofence tool 132 is configured to enable users to define geofences on a virtual map of the golf course. The geofences may be of various types, and different types of geofences may be used for different purposes. The geofences of primary relevance to the instant disclosure are those which define regions where vehicles are unlikely to travel. Such geofences may be referred to herein as “impractical zones.” They may also be referred to simply as “geofences.” The geofence tool 132 may define impractical zones using data structures, such as JSON (JavaScript Object Notation) documents, XML (Extensible Markup Language) files, or other data files or formats. The data structures store parameters relevant to the impractical zones, such as their locations and shapes, as well as offset adjustments to be applied when vehicle locations fall within the associated zones. The user interface 114 is preferably a graphical user interface that allows intuitive control of the geofence tool 132 and other functions of the course manager 130.

The golf carts 150 of FIG. 1 are normally motorized vehicles, powered by gasoline or electricity, which may be freely driven around the golf course, both on and off golf paths. Each golf cart 150 has many components, which include a body 152, wheels 154, and a console 156. The console 156 presents an electronic interface to a driver of the golf cart 150.

As shown in the expanded view at the bottom of FIG. 1, the console 156 may include a GPS receiver 160, a wireless interface 162, and a display 164. The GPS receiver 160 is configured to receive GPS signals from satellites and to convert the signals into location coordinates, such as latitude and longitude. The wireless interface 162 is configured to receive wireless signals, such as Wi-Fi and/or GSM signals, from the server 110 and optionally from other sources. The display 164 provides viewable output and may include a touchscreen for receiving driver input. One should appreciate that the display 164 may be omitted in some embodiments. The console may optionally include one or more loudspeakers, microphones, and the like (not shown), for enabling audio communication with the club house and/or with other carts.

The console 156 further includes one or more processors 170 and memory 180, which together form control circuitry constructed and arranged to carry out various functions to be performed by the console. The memory 180 may include a cart manager 190, i.e., a software program for assisting with cart functions. The cart manager 190 itself may include or have access to a mapping module 192 and a user interface 194. The mapping module 190 is configured to receive current locations of the golf cart from the GPS receiver 160 and to apply corrections to the current locations based on offsets defined by encountered geofences (impractical zones). The user interface 194 provides graphical output to the display 164 and may receive input from an associated touchscreen.

In example operation, a user of the server 110 defines one or more impractical zones on a virtual map of the golf course. The server 110 stores definitions of the impractical zones in associated data structures. In some examples, the impractical zones may previously have been defined on the server 110, or they may have been transferred to the server from some other computer. The server 110 may send the data structures to one or more golf carts 150, which receive the data structures and apply them locally to their own virtual maps. Alternatively, the server 110 may send the complete virtual map to the golf carts, including the defined data structures for impractical zones and any other geofences. Each golf cart 150 receives the data structures (or complete map information) via the wireless interface 162 and stores the data structures in memory 180. The golf carts 150 may then operate mostly on their own, with occasional communication with the server 110.

As a golf cart 150 travels around the golf course, the GPS receiver 160 receives GPS signals and outputs the current location. The mapping module 192 receives the current location and places it on a local version of the virtual map. If the current location falls within an impractical zone defined on the map, the mapping module 162 may adjust the current location by applying a spatial offset, which may be defined by the impractical zone itself, e.g., as a parameter stored in the data structure provided for that impractical zone. The spatial offset may have both a direction and a magnitude, which may be tailored to the particular impractical zone. As the golf cart continues driving, it may encounter additional impractical zones, meaning that the current, corrected location of the cart falls within those impractical zones. For each current location falling within an impractical zone, the mapping module 192 may apply a respective spatial offset, which may be summed with the previous offsets, to produce an overall correction.

As GPS errors tend to be consistent in the short term, offsets applied upon encounters with impractical zones may be persisted for a period of time. Preferably, such offsets are configured to decay back to zero over a determined interval, which may be defined as a parameter in the data structure for each impractical zone. Also, each impractical zone may define a maximum cumulative offset correction that may be applied as a result of an encounter with that impractical zone. In some examples, a standard decay rate and/or maximum cumulative offset may be established as a common setting for all impractical zones (although at the loss of some capability).

One should appreciate that the particular functions ascribed above to the server 110 and the golf carts 150 are merely examples and are not intended to be limiting. For example, golf carts may operate entirely independently of any server, having received map information online or via software media (thumb drive, disk drive, etc.). As another example, golf carts may operate in closer communication with the server 110 than described above, such as by sending their current GPS readings back to the server, where they may be corrected by the server rather than by the cart. Many arrangements are contemplated.

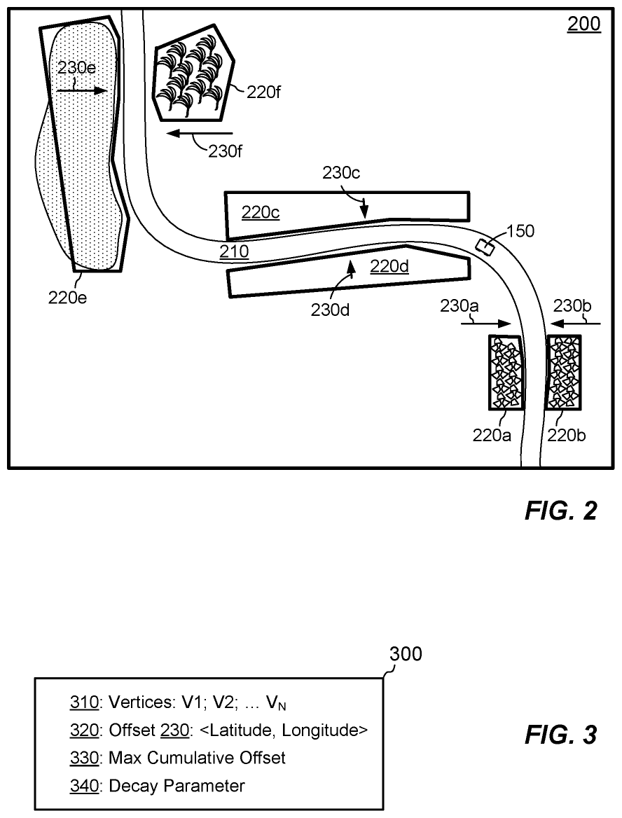

FIG. 2 shows an example virtual map 200, which may be displayed by the server 110 and, in some cases, by the console 156 in the golf cart 150. Here, a particular geographical region of the golf course is shown. Multiple impractical zones 220 (geofences) have been defined in the depicted region. These zones include zones 220a and 220b, which encompass rocky areas, zones 220c and 220d, which encompass grassy areas, zone 220e, which encompasses part of a body of water, and zone 220f, which encompasses an area of dense vegetation. Zones 220c and 220d may be drivable regions that are passable by the cart 150 but are unlikely to be traveled, given that a nearby path 210 typically provides better driving conditions.

In an example, the depicted impractical zones 220 are defined by a user of the server 110 operating the user interface 134. Each impractical zone 220 has a particular shape (e.g., a polygon), which may be defined by a set of vertices, with each vertex specified by a respective pair of coordinates (e.g., latitude and longitude). Each impractical zone 220 may also define a respective spatial offset, shown pictorially by arrows 230a, 230b, 230c, 230d, 230a, 230e, and 230f. Each spatial offset 230 may have a magnitude, as indicated by the length of the line, and a direction, as indicated by the arrow. In an example, each spatial offset 230 has two orthogonal components, such as latitude and longitude (although other components for other coordinate systems may be used).

As the golf cart 150 is driven along the golf path 210, the current location (determined at least in part based on GPS reading) may place the golf cart in any of the depicted impractical zones 220. Each time this occurs, an adjustment is made to the current location based on the spatial offset specified for the respective impractical zone. Different impractical zones 220 may adjust the current location in different directions, which may be orthogonal or have orthogonal components, thus tending to correct the GPS position of the cart in both latitude and longitude.

FIG. 3 shows an example data structure 300 that stores parameters for an impractical zone 220. A variety of parameters may be stored. Some examples include:
Vertices 310: A set of vertices (e.g., latitude and longitude coordinates) that define a polygon that encompasses the impractical zone.
Offset 320: A spatial offset to be applied upon each encounter with the impractical zone. May be expressed as a latitude component and a longitude component, which together form an offset vector having a magnitude and a direction.
Maximum Cumulative Offset 330: A maximum offset that may be applied to current locations of the golf cart based on successive encounters with the impractical zone. For example, spatial offsets can accumulate for successive encounters with the impractical zone, and this parameter limits the maximum amount of correction that can be applied. May have the same units and components as offset 320.
Decay Parameter 340: A rate at which cumulative offsets from one or more encounters with the impractical zone decay to zero. Decay parameters apply only when current locations fall outside the impractical zone in which they are defined.

One should appreciate that the above-described parameters may be expressed in a variety of mathematically equivalent ways. For example, the offset 320 may be expressed as an independent pair of components, or it may be expressed as a fraction, decimal, or percentage of the maximum cumulative offset 330. If the latter arrangement is used, a setting of 0.05 would mean that 20 encounters would be needed before the maximum cumulative offset 330 would be attained, whereas a setting of 0.2 would mean that only 5 encounters would be needed.

In some examples, the decay parameter is expressed as a fraction, decimal, or percentage. A value of 0.001 would mean that the cumulative offset for the impractical zone is reduced by 0.1% of its initial value upon each subsequent GPS location measurement (location measurements may be made at regular intervals, such as once per second). After 1000 consecutive location measurements that fall outside the impractical zone, the effect of the cumulative offset for the impractical zone reaches zero. A decay parameter of 0.05 means that the correction falls to zero after 20 measurements.

Referring back to FIG. 2, it can be seen that different impractical zones 220 can advantageously have different offsets 320, different maximum cumulative offsets 330, and different decay parameters 340. For example, impractical zones 220a and 220b can have relatively large offsets 320, given a high degree of certainty that the cart 150 is not driving over large rocks, but they may also have relatively small maximum cumulative offsets 330, given that they are typically encountered only briefly. They may also have relatively fast decay rates, particularly if GPS signals are known to be distorted in the area. By contrast, impractical zones 220c and 220d may be located in wide, open areas, where GPS signals are likely to be less distorted. Decay rates 340 may thus be slower here, such as less than half the decay rates of zones 220a and 220b. Offsets 320 may also be smaller, such as less than half those of zones 220a and 220b, given that there are greater distances over which corrections can be asserted. Maximum cumulative offsets 330 may be larger. One should appreciate that providing slow decay rates for an impractical zone extends the period of time over which the correction from that impractical zone may be asserted. Thus, even if the cart drives in an area where there are no impractical zones, such as in the middle of an open fairway, it can still benefit from the corrections applied by the impractical zones encountered earlier.

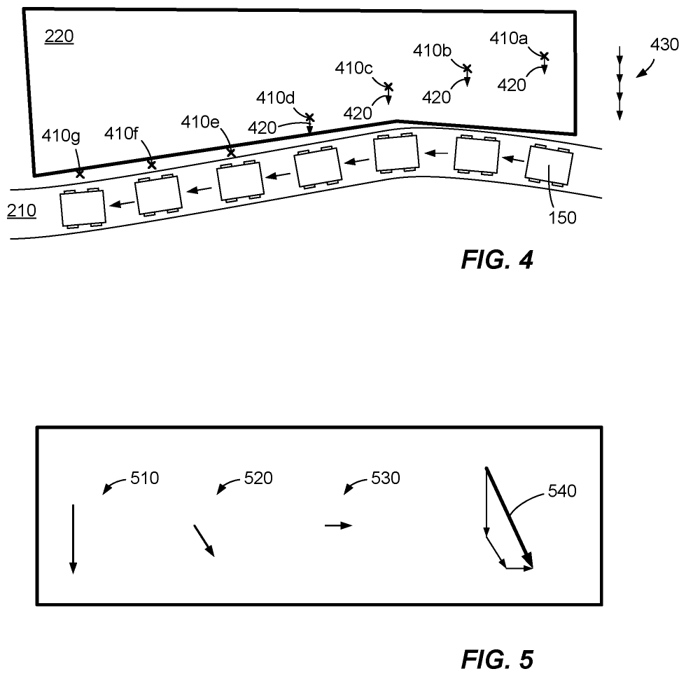

FIG. 4 shows an example in which multiple location corrections are made in response to respective encounters with the same impractical zone 220. As the cart 150 drives from right to left, a first GPS measurement places the location 410a of the cart (shown with an “x”) within the impractical zone 220, resulting in an offset 420 being applied to location 410a (offset 420 is an example of offset 320 in FIG. 3). The location 410a may reflect corrections from previously encountered impractical zones, or it may be completely uncorrected.

Proceeding to the left, a next GPS measurement 420b has already been corrected once by the offset 420 and is thus closer to the true location of the cart. Yet location 410b is still inside the impractical zone 220. Thus, the offset 420 is applied again. The offset 420 is further applied for location measurements 410c and 410d, which brings the corrected location very close to the boundary of the impractical zone 220. The next measurement 410d falls outside the impractical zone 220 and thus receives no further correction. Rather, a cumulative correction 430 (shown to the right) begins to decay in accordance with the decay parameter 340, causing corrected measurements 410e, 410f, and 410g to sag slightly back. The cart 150 then carries the cumulative correction 430 forward as it proceeds along the path 210 or even if it diverts from the path, until the cumulative correction decays to zero.

FIG. 5 shows an example arrangement for combining cumulative corrections resulting from encounters with multiple impractical zones 220. Here, it is assumed that the cart has encountered three impractical zones 220, resulting in respective cumulative offsets 510, 520, and 530. These cumulative offsets may be partially decayed, although one of the offsets may be un-decayed if the current location is still within the corresponding impractical zone. Fully decayed offsets are not shown and need not be considered. To combine cumulative offsets 510, 520, and 530, a vector sum is calculated of the cumulative offsets. The resultant offset 540 may then represent an overall correction of raw GPS coordinates from the GPS receiver 160.

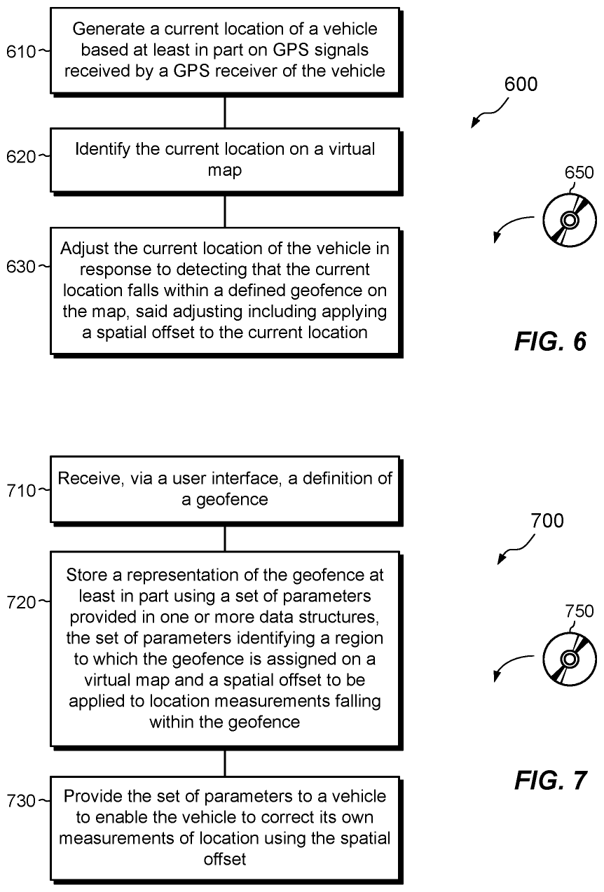

FIGS. 6 and 7 show example methods that may be carried out in connection with the environment 100. The various acts of the depicted methods may be ordered in any suitable way. Accordingly, embodiments may be constructed in which acts are performed in orders different from those illustrated, which may include performing some acts simultaneously.

FIG. 6 shows an example method 600 of correcting location measurements. Method 600 is typically performed, for example, by the software constructs described in connection with FIG. 1, which reside in the memory 180 of the cart console 156 and are run by the processor or processors 170.

At 610, a current location of a vehicle 150, such as location 410a (FIG. 4), is generated based at least in part on GPS signals received by the vehicle, such as by the GPS receiver 160 in the console 156. The current location may be a raw GPS measurement. Alternatively, the current location may be corrected based on previous encounters with impractical zones or based on other correction techniques.

At 620, the current location of the vehicle is identified on a virtual map. For example, location 410a (FIG. 4) of the cart 150 is identified on the virtual map 200. One should appreciate that it is not necessary for the virtual map to be displayed in order to identify the current location of the vehicle. Rather, the location may be identified by an internal operation of the mapping module 192.

At 630, the current location (e.g., 410a) of the vehicle 150 is adjusted in response to detecting that the current location falls within a defined geofence, such as an impractical zone 220, on the map 200. The adjustment includes applying a spatial offset to the current location, such as offset 420 in FIG. 4.

FIG. 7 shows an example method 700 of correcting location measurements. Method 700 is typically performed, for example, by the software constructs described in connection with FIG. 1, which reside in the memory 120 of the server 110 and are run by the processor or processors 114.

At 710, a definition of a geofence may be received via a user interface. For example, a user of server 110 may operate the user interface 134 of the course manager 120 to define an impractical zone 220 on a virtual map 200 of the golf course. Alternatively, a definition of the impractical zone 220 may be received in a data transfer from another computer, which may include downloading the definition over the Internet.

At 720, a representation of the geofence (impractical zone 220) is stored at least in part using a set of parameters (e.g., parameters 310, 320, 330, and 340) provided in one or more data structures 300. The set of parameters identifies a region to which the geofence is assigned on a virtual map 200 and a spatial offset 320 to be applied to GPS-based location measurements.

At 730, the set of parameters (e.g., 310, 320, 330, and 340) is provided to a vehicle 150 to enable the vehicle to correct its own measurements of location using the spatial offset 320.

An improved technique has been described that corrects errors in locations of a vehicle 150 in response to current locations falling within one or more geofences 220 that define regions where the vehicle is unlikely to be traveling. In response to a current location (e.g., 420a) of the vehicle falling within the bounds of such a geofence 220, the technique adjusts the current location by a defined offset 320. The offset 320 has the effect of modifying the current location toward a more likely, actual location of the vehicle.

Having described certain embodiments, numerous alternative embodiments or variations can be made. For example, although embodiments have been described in connection with golf carts, this is merely an example. Alternatively, embodiments may be constructed using other types of GPS-enabled vehicles, such as automobiles, trucks, snow mobiles, or the like.

Also, impractical zones 220 have been shown and described as having only a single spatial offset. This too is merely an example. Alternatively, an impractical zone may have multiple offsets in respective portions of the impractical zone. As another example, the spatial offset of an impractical zone may be defined algorithmically, such as by specifying a gradient of offset values that vary over the area of the impractical zone in a determined manner.

Also, impractical zones 220 have been described as user-generated objects. This is also merely an example. For instance, impractical zones may be created algorithmically, such as by analyzing geographical features of a golf course and creating impractical zones in areas that the features indicate would be difficult or impossible to drive on with golf carts. In some examples, parameters of impractical zones may be tuned automatically, such as by applying machine learning techniques that optimize for accurate GPS readings.

Although impractical zones have been described as areas where golf carts are unable or unlikely to pass, impractical zones may also include areas where golf carts historically do not pass. For example, by monitoring cart locations over time and under various conditions, it may be determined empirically that there are certain areas where golf carts do not pass. Such areas may be good candidates for impractical zones.

Further, although embodiments have been presented in connection with GPS-determined locations, embodiments are not limited to GPS but rather may include alternative location-determining technologies, such as Bluetooth beacons, Wi-Fi localization, camera-based localization, and so forth. In some embodiments, GPS is one of multiple factors used in determining locations. Any such location-determining technologies may be improved upon using the geofence-based techniques presented herein.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as media 650 and 750 in FIGS. 6 and 7). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of correcting location measurements, comprising:
generating a current location of a vehicle based at least in part on GPS (Global Positioning System) signals received by a GPS receiver of the vehicle;
identifying the current location on a virtual map; and
adjusting the current location of the vehicle in response to detecting that the current location falls within a defined geofence on the map, said adjusting including applying a spatial offset to the current location.

2. The method of claim 1, wherein the spatial offset has a direction toward a vehicle path identified on the map.

3. The method of claim 1, wherein the spatial offset is defined by a set of parameters associated with the geofence, and wherein adjusting the current location of the vehicle includes accessing the spatial offset from the set of parameters.

4. The method of claim 3, wherein the spatial offset has at least two orthogonal components that form a correction vector having a magnitude and a direction.

5. The method of claim 3, wherein the current location is one of multiple current locations generated based at least in part on GPS signals received by the vehicle over time, and wherein the method further comprises applying corrections repeatedly and cumulatively in response to current locations of the vehicle repeatedly falling within the geofence.

6. The method of claim 5, wherein the set of parameters that define the geofence further define a maximum cumulative correction that can be applied in response to current locations of the vehicle repeatedly falling within the geofence.

7. The method of claim 6, wherein the set of parameters associated with the geofence further defines a decay parameter, and wherein the method further comprises reducing a cumulative correction based on the decay parameter in response to current locations of the vehicle falling outside of the geofence.

8. The method of claim 4, wherein the geofence is a first geofence, and wherein the method further comprises, in response to detecting that a second current location of the vehicle falls outside the first geofence and within a second geofence defined on the map, adjusting the second current location of the vehicle at least in part by applying a second spatial offset to the second current location, the second spatial offset defined by a second set of parameters associated with the second geofence.

9. The method of claim 8, wherein the correction vector is a first correction vector, wherein a second correction vector is formed by the second spatial offset, wherein the second correction vector has a direction that differs from the direction of the first correction vector, and wherein adjusting the second current location is based on both the first correction vector and the second correction vector.

10. The method of claim 8, wherein the first geofence encompasses an undrivable region that is impassible by the vehicle, and wherein the second geofence encompasses a drivable region that is passable by the vehicle but does not include a defined path for the vehicle.

11. The method of claim 10, wherein a magnitude of the second offset is less than half the magnitude of the offset associated with the first geofence.

12. The method of claim 11, wherein the first geofence has a first offset-decay rate, wherein the second geofence has a second offset-decay rate, and wherein the first offset-decay rate is less than half the second offset-decay rate.

13. A method of correcting location measurements, comprising:
receiving, via a user interface, a definition of a geofence;
storing a representation of the geofence at least in part using a set of parameters provided in one or more data structures, the set of parameters identifying a region to which the geofence is assigned on a virtual map and a spatial offset to be applied to location measurements falling within the geofence; and
providing the set of parameters to a vehicle to enable the vehicle to correct its own measurements of location using the spatial offset.

14. The method of claim 13, wherein storing the representation of the geofence using the set of parameters further includes storing a maximum cumulative correction that can be applied to location measurements that repeatedly fall within the geofence.

15. The method of claim 14, wherein storing the representation of the geofence using the set of parameters further includes storing a decay parameter to be applied to cumulative corrections responsive to location measurements falling outside the geofence after having fallen within the geofence.

16. A vehicle, comprising:
a body;
a computing device; and
a GPS (Global Positioning System) receiver operatively coupled to the computing device,
wherein the computing device includes control circuitry constructed and arranged to:
generate a current location of the vehicle based at least in part on GPS signals received by the GPS receiver;
identify the current location on a virtual map; and
adjust the current location of the vehicle in response to detecting that the current location falls within a defined geofence on the map, the adjustment including applying a spatial offset to the current location.

17. The vehicle of claim 16, wherein the spatial offset has a direction toward a vehicle path identified on the map.

18. The vehicle of claim 16, wherein the current location is one of multiple current locations generated based at least in part on GPS signals received by the vehicle over time, and wherein the control circuitry is further constructed and arranged to apply corrections repeatedly and cumulatively in response to current locations of the vehicle repeatedly falling within the geofence.

19. The vehicle of claim 18, wherein the spatial offset is defined by a set of parameters associated with the geofence, and wherein the set of parameters further define a maximum cumulative correction that can be applied in response to current locations of the vehicle repeatedly falling within the geofence.

20. The vehicle of claim 19, wherein the set of parameters associated with the geofence further define a decay parameter, and wherein the control circuitry is further constructed and arranged to reduce a cumulative correction based on the decay parameter in response to current locations of the vehicle falling outside of the geofence after having fallen within the geofence.
